(19) United States
(12) Patent Application Publication
(10) Pub. No.: US 2024/0199465 A1
(43) Pub. Date: Jun. 20, 2024

(54) WATER TREATMENT FACILITY AND METHOD

(71) Applicant: SUEZ INTERNATIONAL, PARIS LA DEFENSE CEDEX (FR)

(72) Inventors: Caroline BARBÉ, Paris La Défense CEDEX (FR); Delia PASTORELLI, NOGENT-SUR-MARNE (FR)

(21) Appl. No.: 18/554,857

(22) PCT Filed: Apr. 11, 2022
(86) PCT No.: PCT/EP2022/059660

§ 371 Date: Oct. 11, 2023

(30) Foreign Application Priority Data
Apr. 12, 2021 (FR) 2103759

(51) Int. Cl. C02F 9/00; C02F 1/00; C02F 1/24; C02F 1/44; C02F 1/52

(52) U.S. Cl. CPC C02F 9/00; C02F 1/004; C02F 1/24; C02F 1/441; C02F 1/52; C02F 2301/08

(57) ABSTRACT

The invention pertains to the technical field of water treatment. The invention relates to a water treatment facility comprising: supply means A for feeding the water to be treated; optionally a coagulation and/or flocculation zone Z into which the supply means A for feeding the water to be treated E run; a flotation reactor R_{FLO} comprising an inlet and a gravity filter F_{g}, into which water from the flotation reactor R_{FLO} can flow by gravity, the gravity filter having a single-layer filtering media bed distributed over a height of 1 m or less. The facility comprises at least one high-rate monolayer filter (HRMF) for filtering the flotation-filtered water from the gravity filter F_{g}. A facility according to the invention can comprise a desalination and/or potabilization unit using membrane treatment, in particular reverse osmosis, in order to desalinate and/or make the pretreated water from the high-rate monolayer filter drinkable.

### TECHNICAL FIELD OF THE INVENTION

The present invention relates to a water treatment facility intended for the potabilization or desalination of that water, and a method implemented using such a facility. The invention relates more specifically to a pretreatment of seawater or brine water to produce drinking water or industrial-use water, upstream of a membrane treatment step (reverse osmosis, nanofiltration, electrodialysis, membrane distillation, forward osmosis, capacitive deionization, etc.). The invention may also relate to a pretreatment of water that is not very salty, with a view to the potabilization thereof.

### TECHNOLOGICAL BACKGROUND

In the field of water treatment, in particular for desalination or potabilization, the quality of water upstream of the filtration membranes is of the greatest importance for the operation of a facility. This criterion is all the more important when the water to be treated is particularly “difficult” or during episodes of heavy algae development in the water to be treated.

Conventionally, a desalination method comprises a step of filtration on reverse osmosis membranes, preceded by a pretreatment step intended to control the quality of the water passing through the osmosis membranes, to preserve them from possible clogging and/or premature degradation. The pretreatment of the water is generally carried out by independent structures such as a two-layer filter, that is to say with at least two media of different particle size. The two-layer filter can be a gravity or pressure-driven filter. The filtration rates for a first step of pretreating seawater are typically:
between 8 and 13 m/h for gravity two-layer filtration,
between 10 and 15 m/h for pressure-driven two-layer filtration.

The choice of rates of course depends on the quality of water at the inlet as well as of the type and of the size of media used. The international application WO-A-9315021 thus describes a facility comprising a gravity filter through which the water previously treated by flotation passes, at a rate of about 8 m/h. This two-layer filter is 1 m tall and consists of a layer of anthracite superimposed on a layer of sand, or alternatively of a layer of sand.

A two-layer filter is generally implemented with frontal filtration, the water to be pretreated vertically through the filtering medium, the latter having a height of between 1 and 2 m with a particle size decreasing in the direction of the filtration, generally between 0.3 mm and 1.5 mm. The choice of the particle size of the two media is critical in order to ensure good reclassification of the two-layer filter following the backwashes. An example of a two-layer filter is for example described in international application WO-A-2008093017.

The pretreatment can also be carried out in a DAF facility followed by a filtration device, in particular a gravity filtration device. Various documents of the prior art describe a method for treating water comprising a dissolved air flotation (DAF for short) step followed by a gravity filtration step, optionally prior to a membrane filtration step. However, these facilities take up significant ground area.

One solution to this drawback is to combine the structures by designing DAFF (DAF-Filters) or DAF-UF (DAF-Ultrafiltration) facilities. In the case of DAFF, this however requires increasing the height of the filtering medium, which causes an extra cost related to the height of the structure (increase of the CAPEX (investment costs)), and additional head losses.

International application WO-A-2014044619 describes, for example, a facility of the DAFF type comprising a coagulation zone and a flocculation zone to which a flotation reactor is connected, said flotation reactor communicating with a gravity filter arranged such that the water coming from the flotation reactor flows into the gravity filter. Said gravity filter is distributed over a large height, the latter is between 1.5 m and 3 m, and preferably equal to 3 m. The filtering medium may be a single layer, consisting of sand with a particle size of between 0.5 and 0.8 mm, or multilayer, said multilayer media always comprising at least one layer of sand with a particle size of between 0.5 and 0.8 mm. The rate of the filtration step through the gravity filter is between 10 and 30 m/h.

Such DAF-Filter solutions of the prior art tend to obtain water quality such that no additional membrane filtration step is necessary. Therefore, these facilities must use filtration materials with a fine particle size in order to obtain effective filtration and sufficient water quality. These facilities in fact comprise a layer with a particle size of 0.5 to 0.8 mm for the final filtration step.

These solutions have the disadvantage of a rate limited to the filter rate, that is to say between 10 and 30 m/h, and the generation of a large head loss, the head loss being proportional to the height and the particle size of the media, and to the feed flow rate. Indeed, although a “conventional” DAF facility (without a filter) can be used at a rate that can reach 40 m/h, in a DAF-Filter facility according to the prior art, in the presence of conventional material heights, the rate is limited to 12 m/h (the commonly accepted maximum gravity filtration rate). It is also noted that the example of application WO-A-2014044619 mentions the rate of 15 m/h (see page 17 lines 8-11).

Another type of combined solution, denoted “e-DAF” is reported in international application WO-A-2018115500. The facility of WO-A-2018115500 allows the application of treatment rates greater than 30 m/h, leading to treated water with an intermediate quality between the filtered water (on a two-layer or on membrane medium) and floated water (at the outlet of a simple DAF). The application of WO-A-2018115500 comprises a gravity filter which only requires a media layer with a height of less than 1 m, with a particle size advantageously greater than or equal to 1.5 mm, generating little head loss. Such a facility of the “e-DAF” type can then operate at higher rates than a DAF Filter (up to more than 40 m/h), at structure heights equivalent to that of a conventional DAF. In addition, the quality of water at the outlet of the e-DAF being of better quality than that at the outlet of DAF, the rate applicable in the subsequent treatment steps can therefore be significantly increased.

Application WO-A-2018115500 further describes the implementation of a subsequent refining step, namely ultrafiltration. Such a combination makes it possible to use a larger media size in the gravity filtration step. Such a combination thus makes it possible to achieve an attractive compromise between head losses and water quality at the outlet of the “e-DAF” facility, and to achieve increased rates during the ultrafiltration step, greater than 60 L·m⁻²·h⁻¹ (LMH). The structure intended for implementing ultrafiltration therefore has lower footprint than with a conventional DAF-UF system.

However, this “e-DAF-UF” combination is not suitable for the treatment of certain types of water, in particular when the organic load is large and/or fluctuating, or when the temperature amplitude of the inlet water is significant. Indeed, although effective with respect to colloidal particles, ultrafiltration (UF) has fairly low removal efficiency with respect to dissolved organic matter that causes the development of microorganisms which can generate biofouling on reverse osmosis membranes.

Furthermore, the UF membranes are sensitive to variations in the quality of the supply water—in particular the variations in viscosity which greatly depend on the temperature—and require constant adjustments, such as reductions in the production flow in particular.

Furthermore, the use of ultrafiltration membranes for water with a significant organic load involves significant consumption of chemicals in order to perform chemically enhanced backwashing (CEB or CEBW for short) so as to maintain filtration efficiency at a given flow. The need to carry out backwashing with or without chemicals can thus lead to a heavy loss of water and degrade the degree of conversion of the pretreatment, which leads to an additional cost in terms of energy, as the water not used for production nevertheless must be conveyed to the system.

In addition, the cost of the membranes, which must be replaced regularly, is quite large and impacts both the initial investment and operational expenditure.

Finally, UF systems require significant operational skills, as the system is complex with many parameters to be controlled.

There is therefore a need for a method allowing high filtration rates to be carried out while allowing water to be obtained that is of sufficient quality to be usable at the inlet of a method such as reverse osmosis filtration or potabilization, and making it possible to limit the number of washes (backwashes) and to preserve the service life of the equipment, and more particularly the reverse osmosis membranes, in order to limit the operating expenses (OPEX) of the method. The corresponding facility will preferably take up limited ground area and be of a height at most equivalent to the systems of the prior art.

### SUMMARY OF THE INVENTION

To this end, the invention proposes to combine an “e-DAF” type facility with a facility suitable for high-rate media filtration, the media preferably being monolayer.

Thus, according to a first aspect, the invention relates to a water treatment facility comprising:
supply means for feeding the water to be treated,
a flotation reactor comprising at least one first inlet fluidly connected to said supply means,
a gravity filter, said flotation reactor being at least partially superimposed on said gravity filter and communicating with it so that the water coming from said flotation reactor can flow by gravity into said gravity filter, to produce flotation-filtered water, said gravity filter having a single-layer filtering media bed distributed over a height of 1 m or less,
   said gravity filter further comprising an outlet for discharging the flotation-filtered water, and
at least one high-rate media filter, to filter the flotation-filtered water from the gravity filter, comprising at least one inlet fluidly connected to the outlet of the gravity filter, and at least one outlet to discharge the pretreated water.

According to a second aspect, the invention relates to a water treatment method intended for the potabilization or desalination of that water, said method comprising at least one cycle for treating said water comprising:
a) a flotation step within a flotation reactor of the water to be treated, providing flotation water,
b) a step of gravity filtration within a gravity filter of the float water coming from said flotation step a) to supply flotation-filtered water, said flotation reactor being at least partially superimposed on said gravity filter, and said gravity filter having a single-layer filtering media bed distributed over a height of 1 m or less,
c) a step of high-rate media filtration of the flotation-filtered water from the gravity filtration step, in order to provide pretreated water.

The water pretreated by the method can then serve as feed water for a desalination unit or desalinization unit, in particular by reverse osmosis. The pretreated water can also be conveyed to a means of potabilization. In other words, the pretreated water obtained in step c) is subjected to a subsequent step of desalination or potabilization. by reverse osmosis.

The method of the invention can be implemented in a facility according to one of the embodiments described above or below.

Significantly, such a facility makes it possible to implement a method for pretreating water to be desalinated and/or potabilized, wherein the rate of the pretreated water (that is, resulting from step c)) is greater than 15 m/h. Thus, at equal volume, the plant takes up limited ground area, and requires significantly less expensive facilities.

Furthermore, the quality of the pretreated water (that is, resulting from step c)) is sufficient to allow an immediately subsequent membrane filtration step, and in particular a reverse osmosis treatment.

The invention can be considered a flotation followed by filtration on a two-layer medium that would have been “decoupled”, that is, the filtration on the first layer—generally the layer of greater particle size—is integrated into the flotation structure that comprises the gravity filter, while the filtration on the second layer—typically a finer particle size—is implemented in a separate, high-rate filter. This conceptual “decoupling” has the consequence of:
making it possible to overcome problems specific to two-layer media filters: the reclassification of the media after washing (and more particularly back-washing), thus offering a wider choice of combination of media particle size, and due to a reduction in costs, by the use, for example, of a medium of greater particle size, in particular in the “eDAF” facility;
obtaining a water of sufficient quality to supply a downstream process, in particular reverse osmosis,
increasing the feed rate of the pretreatment, though without compromising the quality of the water supplying the desalination process or potabilization by reverse osmosis downstream.

Indeed, this new combination addresses the disadvantages of the prior art:
High-rate media filtration is a robust method capable of minimizing the impact of water quality variations, without requiring significant adjustment;
It is recognized (see in particular Badruzzaman et al. Desalination 449 (2019) 78-91) that, for water with high algal bloom potential, the risk of developing a biofilm on the surface of the reverse osmosis membranes can be up to twice as low with water pretreated by filtration (essentially gravity) on media, relative to an equivalent water treated by ultrafiltration, despite the fact that ultrafiltration produces water less charged with colloidal particles (the silt density index, or SDI, exiting a UF pretreatment is lower);
A filter with media does not require chemical cleaning, which entails less water loss, and the limitation or even elimination of cleaning chemicals;
A filter with media requires a low operational cost, because the media is rarely replaced in its entirety.

### DETAILED DESCRIPTION

The invention therefore relates to a water treatment facility comprising:
supply means A for feeding the water to be treated E,
a flotation reactor R_{Flo} comprising at least one first inlet I_{Flo} fluidly connected to said supply means A,
a gravity filter F_{g}, said flotation reactor R_{Flo} being at least partially superimposed on said gravity filter F_{g} and communicating with it so that the water coming from said flotation reactor R_{Flo} can flow by gravity into said gravity filter F_{g}, to produce flotation-filtered water, said gravity filter F_{g} having a single-layer filtering media bed distributed over a height of 1 m or less,
   said gravity filter F_{g} further comprising an outlet O_{Fg} for discharging the flotation-filtered water, and
at least one high-rate media filter, to filter the flotation-filtered water from the gravity filter F_{g}, comprising at least one inlet I_{HRMF} fluidly connected to the outlet O_{Fg} of the gravity filter F_{g}, and at least one outlet O_{HRMF} to discharge the pretreated water.

The facility is more particularly a water desalination or potabilization facility.

“Gravity filter” means a porous medium comprising at least one layer of granular filtering media, whereby a solid-liquid mixture is made to percolate, the solid particles ideally being retained in the intergranular spaces over the majority of the layer height.

A gravity filter essentially requires gravity to percolate the water and any particles (the filter is generally open to the atmosphere), unlike a high-rate filter.

“Filtering media” within the meaning of the invention means an “active” granular medium in the filtration step, that is to say that it is responsible for filtration, either by its particulate retention properties (particle size), organic retention (biofiltration), adsorption or absorption properties. Filtration may be effective at the surface or in depth depending on the type of media chosen. In general, the medium has a relatively small particle size, in particular less than 5 mm, and preferably less than 2 mm. A “monolayer” or “single-layer” filtering medium is understood to mean a filtering medium whose composition is homogeneous regarding both its particle size and its composition. The filtering media bed may be deposited on a “support layer” which does not participate in the filter: such a support layer aims to equalize the bottom of the filter, in particular by covering the pipe. The media used for the support layer are generally non-porous (therefore “inert” in terms of filtration), and typically have a particle size greater than that of the filtering media, greater than 2 mm. It is most often a gravel or garnet.

Particularly advantageously, the single-layer filtering media bed of the gravity filter is distributed over a height equal to or greater than 0.2 m and less than or equal to 1 m, for example over a height of between 0.5 and 1 m.

Particularly advantageously, the filtering media bed of the gravity filter consists of a layer of a granular material having a particle size greater than or equal to 0.8 mm, preferably greater than or equal to 0.8 mm and less than or equal to 5 mm, and preferably greater than or equal to 0.8 mm and less than or equal to 4 mm.

Particularly advantageously, the filtering medium consists of a layer of a granular material having a particle size equal to or greater than 0.8 mm, preferably equal to or greater than 1.0 mm and less than or equal to 5 mm, in particular equal to or greater than 1.2 mm and less than or equal to 5 mm, preferably equal to or greater than 1.2 mm and less than or equal to 3 mm, for example between 1.5 and 2.5 mm.

A granular material is characterized by various parameters, in particular the particle size, which is defined by the pair: effective size (ES) and uniformity coefficient (UC), the shape of the grains: angular (crushed material), round (river or sea sand), or more-or-less flat (characterized by a flattening coefficient), and its friability, which makes it possible to choose the materials capable of being used in filtration without risk of producing fine particles (that is, dust whose particle size makes it too small to be used) caused by washing operations, and porosity.

The choice of the most appropriate medium for the facility is carried out by a person skilled in the art according to the known characteristics of each of the materials. This choice depends on the nature of the water to be filtered (direct filtration of raw water, filtration of settled water, secondary or tertiary wastewater filtration) and the quality of the water that it is desired to obtain. It also depends on the type of filter used and on the available head loss.

Particularly advantageously, the granular material is chosen from: anthracite, pumice stone, expanded clays (in particular the one known by the trade name Filtralite), activated carbon, zeolite, glass beads, polymer beads, or ceramic beads. These various materials can be chemically or biologically coated or treated to improve their properties.

According to an even more particular aspect, in a facility according to the invention, the granular material of the filtering medium of the gravity filter is anthracite, pumice stone or expanded clay.

According to an even more particular aspect, in a facility according to the invention, the gravity filter has a monolayer anthracite bed, the anthracite being characterized by a particle size equal to or greater than 0.8 mm and less than or equal to 5 mm, and preferably greater than or equal to 1.0 mm and less than or equal to 3 mm, for example between 1.5 and 2.5 mm. Alternatively, the anthracite may be replaced by pumice stone or expanded clay.

Particularly advantageously, the flotation reactor comprises a lower wall that comprises, at least in part, the filtering medium. More particularly, the lower wall of said flotation reactor comprises the filtering medium.

Particularly advantageously, at least part of the lower wall of the flotation reactor comprises a floor supporting said filtering medium. Preferably, in a facility according to the invention, the lower wall of said flotation reactor comprises a floor supporting said filtering medium. The filtering medium may consist of bumps integrated into reinforced polyester tiles, prefabricated concrete slabs or simply in a monolithic slab made of reinforced concrete. The floor may also consist of polymeric (plastic derived from a polyolefin for example) or metal tiles supporting said filtering medium.

The role of said floor is to provide:
a uniform distribution of the filtered water by avoiding preferential passages when rates are high,
a uniform distribution of the washing fluids, and most particularly of the washing air,
air- and water-tightness, in particular in the washing phase,
mechanical resistance to upward (washing) and falling (filtration, rapid drainage) forces,
durable operation without intervention.

Among the floors that can be used in a facility according to the invention, mention may be made of a floor of the type known under the trade name “Degrémont®”, a floor of the type known under the trade name “Leopold®” or of the type known under the trade name “Tetra® LP Block de DE NORA”.

According to a particular embodiment, the apparatus further comprises at least one washing means, in particular a backwashing means, of said gravity filter. The facility may comprise any type of suitable washing means; according to a particular aspect, the washing means comprises means for the counter-current injection of water and/or air. The gravity filter may gradually become clogged during its use. In order to maintain an adequate filtration performance level, and depending on the nature of the water treatment facility, washing cycles must be regularly implemented. Not washing may lead to the clogging of some zones, leaving the water only a reduced passageway, whereupon the head loss increases more quickly, and the filtration becomes locally faster and less efficient. These washing cycles most often consist of injecting water, and optionally counter-current air, through the gravity filter, and therefore consist of backwashing. The water, and optionally air, are injected using injection means well-known to the person skilled in the art, and make it possible to clear out the material accumulated in the gaps of the filtering medium; said material will then be disposed of. In the case where pretreatment is followed by a reverse osmosis filtration step, it is also possible to use the concentrate/retentate from the reverse osmosis step in order to carry out the washing.

“High-rate media filter” or high-rate monolayer filter (HRMF) refers to a porous medium comprising at least one layer of filtering granular media, through which a solid-liquid mixture is filtered at high speed (that is to say at a rate greater than 12 m/h, and preferably greater than or equal to 15 m/h), the solid particles ideally being retained in the intergranular spaces over the majority of the layer height. A high-rate media filter can be a gravity or pressure-driven filter. A filter HRMF comprises at least one layer of filtering media on the surface of which a cake of solid particles is formed; preferably, it is monolayer. A filter HRMF generally comprises multiple filtration modules in parallel.

Since the water quality at the outlet of the flotation-filtration reactor (e-DAF) is better than that at the outlet of a simple “DAF”, a single layer of filtering media for the high-rate filter is sufficient. Said filtering media bed of the high-rate filter HRMF will therefore preferably be a single layer. In a particularly advantageous manner, the filtering media bed, preferably single-layer, is distributed over a height equal to or greater than 0.2 m and less than or equal to 1 m, preferably between 0.4 m and 1 m. In a preferred manner, the filtering media bed, preferably single-layer, is distributed over a height equal to or less than 0.8 m or 0.7 m, or even 0.5 m. Thus, in a particularly preferred manner, the filtering media bed, preferably single-layer, is distributed over a height greater than or equal to 0.2 m and less than or equal to 0.8 m, preferably between 0.4 m and 0.7 m.

Furthermore, the high-rate media filter is generally pressure-driven. In this case, the overpressure applied relative to the atmospheric pressure is generally between 0.4 and 20 bar, in particular between 0.4 and 5 bar.

Advantageously, the filtering media bed of the high-rate filter HRMF is composed of a layer of fine granular material, having a particle size of less than or equal to 1 mm, preferably between 0.1 and 1 mm, and even more preferably between 0.2 and 0.6 mm.

As for the gravity filter, the choice of the filtering media that is most suitable for the high-rate filter HRMF is carried out by a person skilled in the art according to the known characteristics of each of the materials. Advantageously, the granular material of the filtering medium of the high-rate filter HRMF is chosen from: anthracite, pumice stone, expanded clay (in particular Filtralite), activated carbon, zeolite, sand, glass beads, polymer beads, or ceramic beads. These various materials can be chemically or biologically coated or treated to improve their properties. Preferably, it is sand.

The filtering media bed of the high-rate filter HRMF may be deposited on a “support layer” which does not participate in the filter: such a support layer aims to equalize the bottom of the filter, in particular by covering the pipe. The media used for the support layer generally have a particle size greater than that of the filtering media, greater than 2 mm. It is most often gravel.

An example of a high-rate media filter is described for example in international application WO-A-2014012167. Such a filter comprises hydroejectors arranged so as to create a vortex above the filtering medium, and generating tangential filtration of the fluid. Any suspended media particles thus remain in the circulation flow, while the liquid can pass through the filtering medium under the effect of the pressure. However, this technology is more energy-consuming than conventional front filtration.

Preferentially, a front filter, which is less energy-intensive, and therefore more economical, will however be used. An example of a front filter is that marketed by SUEZ under the trade name Seaclean.

In the same way as the gravity filter, the high-rate media filter may further comprise at least one washing means, in particular a backwashing means, of said high-rate media filter. The facility may comprise any type of suitable washing means; according to a particular aspect, the washing means comprises means for the counter-current injection of water and/or air. In the case where pretreatment is followed by a reverse osmosis filtration step, it is also possible to use the concentrate/retentate from the reverse osmosis step in order to carry out the washing.

According to one particular embodiment, the facility further comprises a coagulation and/or flocculation zone Z, said coagulation and/or flocculation zone Z comprising at least one inlet I_{Z} and one outlet O_{Z},
the inlet I_{Z} being fluidly connected to the supply means A for feeding the water to be treated E, and
the flotation reactor R_{Flo} comprising at least one inlet connected to the outlet O_{Z} of said coagulation and/or flocculation zone.

For example, all or some of the outlet O_{Z} of said coagulation and/or flocculation zone is connected to the first inlet I_{Flo} of the flotation reactor. According to a variant, the first inlet I_{Flo} of the flotation reactor is connected only to the outlet O_{Z} of said coagulation and/or flocculation zone: according to this alternative form, the water to be treated is therefore considered to be the water resulting from the coagulation and/or flocculation zone. Such an embodiment makes it possible to improve the efficiency of the flotation zone. Indeed, the coagulation/flocculation zone makes it possible to increase the size of the flocs and/or to capture more colloidal material in the form of flocs, which are subsequently extracted from the flotation zone.

Advantageously, the facility may further comprise a coagulation and/or flocculation zone Z₁, said coagulation and/or flocculation zone Z₁ comprising at least one inlet I_{Z1} and an outlet O_{Z1},
the inlet I_{Z1} being fluidly connected to the outlet O_{Fg} of the gravity filter, and the outlet O_{z1} being fluidly connected to the inlet I_{HRMF} of the high-rate media filter HRMF. Adding a second coagulation/flocculation zone makes it possible to have an additional tool in order to lower the clogging index, known as the silt density index (SDI) of highly polluted water. Such a configuration therefore makes it possible to treat a wider range of waters, and in particular water with high SDI.

According to one advantageous embodiment, the facility further comprises a desalination and/or potabilization unit using reverse osmosis U_{RO} to desalinate and/or render potable the pretreated water and produce desalinated water, said unit comprising at least one inlet I_{RO} fluidly connected to the outlet O_{HRMF} of the high-rate media filter HRMF, and comprising at least one outlet O_{RO} to discharge the desalinated water (also called permeate).

The invention also relates to a water treatment method intended for the potabilization or desalination of that water, said method comprising at least one cycle for treating said water comprising:
a) a flotation step within a flotation reactor of the water to be treated, providing flotation water,
b) a step of gravity filtration of the float water coming from said flotation step a) within a gravity filter to supply flotation-filtered water, said flotation reactor being at least partially superimposed on said gravity filter, and said gravity filter having a single-layer filtering media bed distributed over a height less than or equal to 1 m,
c) a step of high-rate media filtration of the flotation-filtered water from the gravity filtration step b), in order to provide pretreated water.

The water to be treated E can be seawater, or a salty industrial water. It may also be turbid water comprising floating suspended material. Thus, the water to be treated according to the invention typically has one or more of the following features:
Turbidity less than or equal to 15 NTU, and/or
Suspended solids content less than or equal to 30 mg/L, and/or
TOC (Total Organic Carbon) value less than or equal to 10 mg/L, and/or
Algae content less than or equal to 100,000 cells/mL, and/or
SDI value at 3 minutes (SDI 3 min) greater than or equal to 15.

The turbidity is measured with a Hach brand turbidimeter, and is expressed in NTU (Nephelometric Turbidity Units).

The measurement of the suspended solids (SS) follows the standard 2540D method approved by the U.S. Environmental Protection Agency (EPA). A known and homogeneous volume of the water to be analyzed is filtered through a pre-weighed fiberglass filter. The filter is then studied at a temperature of 104±1° and then weighed. Increasing the measured mass, divided by the volume of filtered water, thus represents the value of SS in mg/L.

Total organic carbon (TOC) is typically measured using a TOC analyzer, which combines both an oxidation process to transform the organic carbon into carbon dioxide and an apparatus for measuring the carbon dioxide generated.

The algae content is measured by counting by optical microscopy, fluorescence or electron microscopy, by flow cytometry or by molecular techniques.

The silt density index denoted SDI makes it possible to assess, from the clogging of a filter, the presence of particles when the turbidity criterion is no longer sensitive enough. The filtration time is therefore linked to the clog potential of the filtered water. SDI is measured according to the method described in standard ASTM D4189-07(2014) “Standard Test Method for Silt Density Index (SDI) of Water”.

The salinity of the water to be treated E is not a limiting parameter for the invention.

The treatment method may further comprise a preliminary step a0) of coagulation and/or flocculation of the water to be treated before the flotation step a). The water to be treated can then comprise all or some of the coagulated and/or flocculated water obtained in step a0). According to one variant, the water to be treated in step b) is coagulated and/or flocculated water obtained in step a0). Such an embodiment makes it possible to improve the effectiveness of the flotation method, as explained above.

According to this embodiment, the treatment method may further comprise an intermediate step b2) of coagulation and/or flocculation of the flotation-filtered water resulting from step b). According to this alternative, step c) of high-rate media filtration to supply pretreated water is carried out on the water resulting from step b2). Such a configuration therefore makes it possible to treat a wider range of waters, and in particular water with high SDI, as explained above.

This method has the essential advantage of making it possible to achieve a water treatment rate greater than 15 m/h, and may in particular achieve up to 60 m/h. The choice of rates depends on the quality of water at the inlet as well as of the type and of the size of media used.

Advantageously, the bed of monolayer filtering media of the gravity filter is distributed over a height of less than 1 m and consists of a layer of a granular material having a particle size as defined above.

Particularly advantageously, said gravity filtration step is carried out at a rate of greater than 30 m/h, for example at a rate of between 30 m/h and 60 m/h.

According to a particular embodiment, the method further comprises at least one cycle of washing said gravity filter, including a step of backwashing said gravity filter. Preferably, this step is carried out after the gravity filtration step b). Regular washings make it possible to break the cake (which may in particular comprise a biofilm) which forms at the surface of the filtering medium, acting as a “clogging crust”, and to preserve the performance thereof.

Advantageously, the step c) of high-rate media filtration is carried out at a rate of greater than 15 m/h, preferably between 15 m/h and 60 m/h, even more preferably between 20 and 40 m/h. The person skilled in the art will choose the rate as a function of the quality of water at the inlet, of the type and of the size of media, used as well as of the targeted performance.

This may be tangential or frontal filtration under pressure, preferably the filtration is of the frontal type, the water to be pretreated percolating in a substantially vertical direction through the filtering media. The overpressure applied relative to the atmospheric pressure is generally between 0.4 and 20 bar, preferably between 0.4 and 5 bar.

According to a particular embodiment, the method further comprises at least one cycle of washing said high-rate media filter, including a step of backwashing said high-rate media filter. Such backwashing is typically carried out by briefly supplying the filter with washing water, such as filtered water for example, in a counter-current direction. In the case where pretreatment is followed by a reverse osmosis filtration step, it is also possible to use the concentrate/retentate from the reverse osmosis step in order to carry out the washing. Preferably, this step is carried out after the gravity filtration step c). Regular washings make it possible to break the cake (which may in particular comprise a biofilm) which forms at the surface of the filtering medium, acting as a “clogging crust”, and to preserve the performance thereof.

The water treated by the method can serve as feed water for a desalination unit or desalinization unit, in particular by membrane treatment. The membrane treatment may be a reverse osmosis, a nanofiltration, an electrodialysis, a membrane distillation, a forward osmosis, and/or a capacitive deionization. Generally, it is reverse osmosis. The treated water can also be conveyed to a means of potabilization.

Thus, advantageously, the pretreated water obtained in step c) is subjected to a subsequent step of desalination or potabilization by membrane treatment. The membrane treatment may be a reverse osmosis, a nanofiltration, an electrodialysis, a membrane distillation, a forward osmosis, and/or a capacitive deionization. Generally, it is reverse osmosis.

The desalinated water after a membrane treatment, in particular by reverse osmosis, is called permeate and has very little mineral content (very low salinity)—it is in certain cases considered to be free of minerals. The permeate is typically remineralized in a post-treatment step. Remineralization is systematic in the event of potabilization.

According to a particular embodiment, the method for treating water with a view to the potabilization or desalination thereof, said method comprising at least one cycle for treating said water and comprising:
a0) a step of coagulation and/or flocculation of the water to be treated,
a) a step of flotation within a flotation reactor of the water to be treated, optionally resulting from said coagulation and/or flocculation step, providing flotation water,
b) a step of gravity filtration within a gravity filter of the float water coming from said flotation step a) to supply flotation-filtered water, said flotation reactor being at least partially superimposed on said gravity filter, and said gravity filter having a single-layer filtering media bed distributed over a height of less than 1 m,
b2) optionally a step of coagulation and/or flocculation of the flotation-filtered water coming from the gravity filtration step b),
c) a step of high-rate media filtration of the flotation-filtered water resulting from the gravity filtration step b) or of the coagulation and/or flocculation step b2), to provide pretreated water, and
d) a step of desalinating and/or potabilizing the pretreated water resulting from step c) by membrane treatment as described above, and in particular by reverse osmosis.

The method can be implemented in a facility according to one of the embodiments described above. Advantageously, the high-rate media filter is then pressure-driven.

### BRIEF DESCRIPTION OF THE FIGURES

Other features and advantages of the invention will become apparent on reading the following description, with reference to the drawing wherein:

FIG. 1 shows a water treatment facility according to one embodiment of the invention.

### EXAMPLE EMBODIMENT

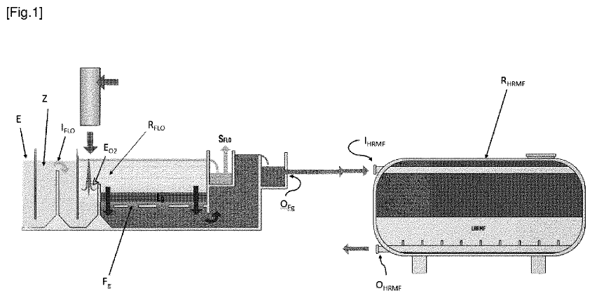

FIG. 1 shows a water treatment facility, said facility comprising:
supply means for feeding the water to be treated A (not shown),
a coagulation/flocculation zone Z wherein said supply means A for feeding the water to be treated E emerge,
a flotation reactor R_{FLO} comprising an inlet I_{flo} connected to the outlet of a coagulation/flocculation zone Z, and
a gravity filter F_{g}, said flotation reactor R_{FLO} being at least partly superimposed on said gravity filter F_{g} and communicating with it so that the water coming from said flotation reactor R_{FLO} can flow by gravity into said gravity filter F_{g},
   said gravity filter F_{g} having a single-layer filtering media bed distributed over a height of less than or equal to 1 m.

In the coagulation/flocculation zone Z of the facility of FIG. 1, a coagulating agent C can be added and then mixed with the water to be treated, by suitable means (not shown). The addition of a coagulating agent such as, in particular, iron chloride or aluminum sulfate leads to the coagulation of the colloidal particles and suspended particles in the water to be treated, in particular the algae, the phytoplankton and some of the organic matter. Once their charges have been neutralized, colloids agglomerate together by mechanical or piston agitation to form “flocs” in the hydraulic coagulation/flocculation zone Z. In the coagulation/flocculation zone Z of the facility of FIG. 1, a flocculating agent F (or coagulation additive) can be added and then mixed with the water to be treated, by suitable means (not shown). The addition of a flocculating agent makes it possible to agglomerate the particles into clusters of greater size. The water, coagulated and further flocculated beforehand, is then conveyed to a zone for injecting oxygen-oversaturated water E_{O2}, nitrogen atmospheric gas or any other appropriate gas. Under the effect of the expansion of the gas inside the flotation reactor R_{FLO}, gas bubbles are formed rising up to the surface of the flotation reactor R_{FLO}, taking with them any flocs present in the water. The mixture of air bubbles and flocs can then be discharged into an overflow of the separation zone S_{FLO} of the flotation reactor, in particular via a chute G (not shown) wherein it can be pushed by means of an overflow or scraping device provided for this purpose.

The facility of FIG. 1 also comprises a gravity filter F_{g}, the flotation reactor R_{FLO} being at least partly superimposed on this gravity filter F_{g} and communicating with it so that the water coming from said flotation reactor R_{FLO} can flow by gravity into said gravity filter Fg. This gravity filter Fg houses a monolayer filtering medium, that is to say one made up of a single layer of a given filter material, said medium being distributed over a height less than or equal to 1 m. The flotation-filtered water coming from the gravity filter Fg is then conveyed via a supply means to a pressure-driven media filter HRMF to then be filtered therein.

The water treatment method implemented by the apparatus of FIG. 1 comprises one or more successive treatment cycles consisting of introducing the water to be treated E, by supply means, A into the coagulation/flocculation tank Z. At least one coagulant reagent C and at least one flocculation reagent F are injected and mixed with the water to be treated. Under the effect of the coagulant reagent, the colloidal and suspended particles present in the water to be treated agglomerate and form flocs. The water is then filtered on the gravity filter F_{g}, the water coming from said filtration is conveyed by a supply means and is then treated by high-rate filtration on an HRMF filter.

Comparative water treatment tests were carried out in a facility according to the invention, with various monolayer gravity filters, of a height varying from 0.5 to 1 m, consisting of a filtering medium (pumice, anthracite and expanded clay) with a particle size of between 1.2 and 3 mm; and in combination with different filters on high-rate media, with a filtering media bed of a height varying from 0.4 to 0.75 m, consisting of a filtering medium (sand) with a particle size of between 0.28 and 0.55 mm.

The rate of passage through each of the gravity filters is also determined. It is about 40 m/h in the “e-DAF” reactor, and about 20 m/h in the high-rate media filter.

Different parameters are measured and compared, in particular the quality of the treated water after filtration by each of the gravity filters, and its adaptation to a subsequent step of desalination or of potabilization by reverse osmosis. In particular, the turbidity is measured with a Hach brand turbidimeter, and the SDI is measured according to the method described in standard ASTM D4189-07(2014) “Standard Test Method for Silt Density Index (SDI) of Water”.

The water to be treated before entering the device of FIG. 1 has the following characteristics:
Turbidity less than or equal to 30 NTU,
Suspended solids content less than or equal to 30 mg/L,
TOC (Total Organic Carbon) value less than or equal to 10 mg/L,
Algae content less than or equal to 100,000 cells/mL, and
SDI value at 3 minutes (SDI 3 min) greater than or equal to 15.

### Comparative Test

The float water resulting from step a) (at the outlet of the DAF) has a turbidity of 1.2 in NTU.

Results of the analyses carried out on the flotation-filtered water obtained from step b), at the outlet of the gravity filter:

| | Pumice Stone 3 mm | | Pumice Stone 1.5 mm | | Anthracite 1.5 mm | | Expanded clay 2 mm | |
|---|---|---|---|---|---|---|---|---|
| Height of filtering media | 0.5 | 0.75 | 1 | 0.5 | 1 | 1 | 0.5 | 0.75 |
| (in m) | | | | | | | | |
| Turbidity (in NTU) | 0.36 | 0.25 | 0.16 | 0.18 | 0.14 | 0.2 | 0.74 | 0.65 |

The SDI 3 min values are greater than 25, and the SDI 15 min values greater than 5. They are therefore considered irrelevant.

The results above demonstrate that, despite effectiveness in reducing turbidity, an additional treatment step is necessary to obtain water with sufficient quality to supply reverse osmosis membranes. Indeed, an SDI 15 minutes value less than 5 is generally required 100% of the time.

### Test According to the Invention

Results of the analyses carried out on the pretreated water obtained from step c), at the outlet of the media filter:

| Inlet water quality | | | | Pretreated water | |
|---|---|---|---|---|---|
| (raw water to E) | | | | (resulting from step c) | |
| SDI 3 | Turbidity | e-DAF | HRMF | SDI 15 | Turbidity |
| min %/min | (NTU) | 40 m/h | 20 m/h | min %/min | (in NTU) |
| 23.9 | 0.9 | Pumice | Sand | 4.92 | <0.2 NTU |
| | | Stone | 0.5 mm | | |
| | | 3 mm | 0.75 m | | |
| | | 1 m | | | |
| 24.2 | 0.9 | Pumice | Sand | 4.03 | <0.2 NTU |
| | | Stone | 0.28 mm | | |
| | | 3 mm | 0.4 m | | |
| | | 1 m | | | |
| >25 | 1.67 | Pumice | Sand | 4.29 | <0.2 NTU |
| | | Stone | 0.5 mm | | |
| | | 1.5 mm | 0.75 m | | |
| | | 0.5 m | | | |
| 17.5 | 0.6 | Pumice | Sand | 3.68 | <0.2 NTU |
| | | Stone | 0.55 mm | | |
| | | 1.2 mm | 0.5 m | | |
| | | 0.75 m | | | |
| 17.5 | 0.6 | Pumice | Sand | 2.96 | <0.2 NTU |
| | | Stone | 0.28 mm | | |
| | | 1.2 mm | 0.4 m | | |
| | | 0.75 m | | | |

These results confirm that the pretreatment of the invention
operating at higher rates than conventional pre-processes
makes it possible to effectively reduce turbidity and maintain adequate water quality to feed reverse osmosis membranes, and does so for all the combinations tested and regardless of the quality of the inlet water.

Furthermore, depending on the combination of media chosen, the performance may be similar to a combination of DAF+UF type, which makes it possible to obtain a below-5 SDI 15 min 100% of the time, and even a below-3 SDI 15 min 90% of the time.

1. A water treatment facility comprising:
supply means for feeding the water to be treated (E),
a flotation reactor (R_{Flo}) comprising at least one first inlet (I_{Flo}) fluidly connected to said supply means,
a gravity filter (F_{g}), said flotation reactor (R_{Flo}) being at least partly superimposed on said gravity filter (F_{g}) and communicating with it so that the water coming from said flotation reactor (R_{Flo}) can flow by gravity into said gravity filter (F_{g}), to produce flotation-filtered water
said gravity filter (F_{g}) having a single-layer filtering media bed distributed over a height of less than or equal to 1 m,
said gravity filter (F_{g}) further comprising an outlet (O_{Fg}) to discharge the flotation-filtered water,
at least one high-rate media filter (HRMF), to filter the flotation-filtered water from the gravity filter (F_{g}), comprising at least one inlet (I_{HRMF}) fluidly connected to the outlet (O_{Fg}) of the gravity filter (F_{g}) and at least one outlet (O_{HRMF}) to discharge the pretreated water, said filtering media bed of the pressure-driven high-rate media filter (HRMF) being distributed over a height equal to or greater than 0.2 m and less than or equal to 1 m and
supply means leading the flotation-filtered water discharged from the gravity filter (F_{g}) by the outlet (O_{Fg}) towards the inlet (I_{HRMF}) of the pressure-driven high-rate media filter HRMF.

2. The facility according to claim 1, characterized in that said single-layer filtering media bed of the high-rate media filter (HRMF) is monolayer.

3. The facility according to claim 1, characterized in that said filtering medium of the gravity filter (F_{g}) consists of a layer of a granular material having a particle size greater than or equal to 0.8 mm, preferably greater than or equal to 1.0 mm and less than or equal to 5 mm, preferably greater than or equal to 1.2 mm and less than or equal to 4 mm, and more preferentially greater than or equal to 1.2 mm and less than or equal to 3 mm.

4. The facility according to claim 3, characterized in that said granular material is chosen from: anthracite, pumice stone, expanded clays, activated carbon, zeolite, glass beads, polymer beads or ceramic beads.

5. The facility according to claim 1, characterized in that a lower wall of said flotation reactor (R_{Flo}) comprises the filtering media.

6. The facility according to claim 5, characterized in that said lower wall of said flotation reactor (R_{Flo}) comprises a floor supporting said filtering medium.

7. The facility according to claim 1, characterized in that said filtering media bed of the high-rate media filter (HRMF) is distributed over a height equal to or greater than 0.2 m and less than or equal to 0.8 m.

8. The facility according to claim 1, characterized in that said filtering media bed of the pressure-driven high-rate media filter (HRMF) consists of a layer of a granular material having a particle size less than or equal to 1 mm, preferably between 0.1 and 1 mm.

9. The facility according to claim 8, characterized in that said granular material is chosen from: sand, expanded clay, anthracite, pumice stone, activated carbon, zeolite or glass beads.

10. The facility according to claim 1, characterized in that the facility further comprises a coagulation and/or flocculation zone Z, said coagulation and/or flocculation zone Z comprising at least one inlet I_{Z} and an outlet O_{Z}, the inlet I_{Z} being fluidly connected to the supply means A for feeding the water to be treated E, and the flotation reactor R_{Flo} comprising at least one inlet connected to the outlet O_{Z} of said coagulation and/or flocculation zone.

11. The facility according to claim 10, characterized in that it further comprises a coagulation and/or flocculation zone (Z₁), said coagulation and/or flocculation zone (Z₁) comprising at least one inlet (I_{Z1}) and one outlet (O_{Z1}), the inlet (I_{Z1}) being fluidly connected to the outlet (O_{Fg}) of the gravity filter, and the outlet (O_{z1}) being fluidly connected to the inlet (I_{HRMF}) of the high-rate media filter (HRMF).

12. The facility according to claim 1, characterized in that it further comprises a desalination and/or potabilization unit using membrane treatment, in particular reverse osmosis (U_{RO}), in order to desalinate and/or make the pretreated water drinkable, said unit comprising at least one inlet (I_{RO}) fluidly connected with the outlet (O_{HRMF}) of the high-rate media filter (HRMF), and comprising at least one outlet (O_{RO}) to discharge the desalinated water.

13. A water treatment method intended for the desalination or potabilization of that water, said method comprising at least one cycle for treating said water comprising:
a) a flotation step within a flotation reactor of the water to be treated, providing flotation water,
b) a step of gravity filtration within a gravity filter of the float water coming from said flotation step a) to supply flotation-filtered water, said flotation reactor being at least partially superimposed on said gravity filter, and said gravity filter having a single-layer filtering media bed distributed over a height of 1 m or less,
c) a step of filtration, within a pressure-driven high-rate media filter, of the flotation-filtered water coming from the gravity filtration step b), and conveyed via a supply means to said high-rate media filter to supply pretreated water.

14. The method according to claim 13, characterized in that the pretreated water obtained in step c) is subjected to a subsequent step of desalination or potabilization by membrane treatment, in particular by reverse osmosis.

15. The method according to claim 13, characterized in that it further comprises a preliminary step a0) of coagulation and/or flocculation of the water to be treated before the flotation step a).

16. The method according to claim 15, characterized in that it further comprises an intermediate step b2) of coagulation and/or flocculation of the flotation-filtered water coming from step b), the step c) of high-rate media filtration to supply pretreated water then being carried out on the water coming from step b2).

17. The water treatment method according to claim 13, characterized in that said gravity filtration step is carried out at a rate of greater than 30 m/h, preferably between 30 m/h and 60 m/h.

18. The water treatment method according to claim 17, characterized in that said step of high-rate media filtration is carried out at a rate of greater than 15 m/h, preferably between 15 m/h and 60 m/h.

19. The water treatment method according to claim 13, characterized in that it further comprises a step d) of desalination or potabilization of the pretreated water coming from step c) by membrane treatment, in particular by reverse osmosis.
